(19) United States
(12) Patent Application Publication
(10) Pub. No.: US 2005/0071253 A1
(43) Pub. Date: Mar. 31, 2005

(54) Contents providing system for portable terminal

(76) Inventor: Soohyun Yang, Seoul (KR)

Correspondence Address: MORGAN & FINNEGAN, L.L.P., 3 WORLD FINANCIAL CENTER, NEW YORK, NY, 10281-2101, US

(21) Appl. No.: 10/493,163

(22) PCT Filed: Oct. 17, 2002
(86) PCT No.: PCT/KR02/01944

(30) Foreign Application Priority Data
Oct. 17, 2001 (KR) 2001-31707 U
Jan. 9, 2002 (KR) 2002-654 U
Feb. 21, 2002 (KR) 2002-5183 U
May 29, 2002 (KR) 2002-16358 U
Jun. 25, 2002 (KR) 2002-19163 U

(51) Int. Cl. G06F 17/60

(52) U.S. Cl. 705/27

(57) ABSTRACT

The present invention relates to a contents-providing system for portable terminal. The present invention includes a communication network, a contents server stored execution programs for operating portable terminal in at least one mode and contents in a form of database so as to support the portable terminal downloading the execution programs and contents in response to a user's request, the portable terminal downloading the execution program and contents from the contents server through the communication network so as to create a new mode and operating the portable terminal using the execution program and contents.

### TECHNICAL FIELD

The present invention relates to a contents-providing system for portable terminal and, in particular, to a contents-providing system for portable terminal, which enables the portable terminal to operate in various service modes as well as a basic voice communication mode.

### BACKGROUND ART

Portable terminals have been widely spread and, recently, one-fourth of the people possess the portable terminals. The communication using the portable terminals is performed as following procedure.

In case a portable terminal A tries to make a call to a portable terminal B, i.e., when the portable terminal A generates a call, a mobile switching center received the call transmits paging messages to the base stations under control of the mobile switching center for locating portable terminal B.

Each portable terminal receives the paging signal through paging channel, extracts a phone number contained in the paging signal, and compares the received phone number with its own phone number. If the received phone number is identical with its own phone number, the portable terminal transmits a response to the serving base station in order for the portable terminal A to output a ring tone.

In this case, the portable terminal B outputs a ring tone through a speaker to notify the user of the call reception for establishing a communication channel.

Generally, various ring tones such as popular music, rhyme, classical music, etc. are stored in a memory while manufacturing the portable terminal. Also, various ring tones are provided by contents providers such that the users can access the provider's web site, download music or sounds (for example, birdcall, chime, and bell sounds), and store the downloaded music/sound in the memory. The music/sounds stored in the memory is selectively used as the ring tone of the portable terminal. Typically, the ring tone downloading is pay service.

Also, the ring tone is recorded and stored into the memory by the user so as to be outputted according to the user's intention. That is, the user records his/her, family's, or friend's voice and set the recorded voice sound as the ring tone (for example, “There is a call for you”) so as to characterize his/her ring tone. However, there is no other functions except for indicating the user that there is the incoming call.

Unlike the wired telephone, the user carries the portable terminal such that the portable terminal may ring in various situation. That is, even though the user can receive the call in a comfortable situation such as in the office, sometimes the user may be in an uncomfortable situation such as in the business meeting.

If the portable terminal rings in this uncomfortable situation, it makes the user upset and irritates other people around. The user may turn off the portable terminal for avoiding this problem and in this case the caller hears an announce message indicating that the user's mobile phone is turned off, or a ringing tone. Accordingly, the caller can not know the caller's situation.

Also, the conventional portable terminal is provided with the key tones associated with the buttons of the key pad such that user can recognize a correct button is pushed. However, the key tones of the conventional portable terminal are fixed as embedded during the manufacturing.

### DISCLOSURE OF INVENTION

The present invention has been made in an effort to solve the above problems. It is an object of the present invention to provide a contents-providing system for portable terminal having two incoming call rejection mode, i.e., a first incoming call rejection mode in which the receiving portable terminal auto-answers the calling portable terminal with a previously registered background music sound or text message based one the caller's phone number and a second incoming call rejection mode in which the receiving terminal transmits a voice or text message to indicating the user is in the communication unavailable situation to all the calling portable terminals.

It is another object of the present invention to provide a contents-providing system for portable terminal, which is capable of reporting the incoming calls received in the communication unavailable situation to the user with a voice or text message such that the user can call to the counterpart user.

It is another object of the present invention to provide a contents-providing system for portable terminal, which is capable of automatically establishing a communication line to a counterpart terminal with the phone number stored in the first incoming call rejection mode after the first incoming call rejection mode is released.

It is another object of the present invention to provide a contents-providing system for portable terminal, which is provided with a voice recognition circuit so as to produce a background music sound according to a user's voice command.

It is another object of the present invention to provide a contents providing system for portable terminal which is cable of providing and outputting background music through a speaker during the conversation.

It is another object of the present invention to provide a contents providing system for portable terminal, which is capable of transmitting background music to a counterpart terminal such that the users can make a conversation while listening to the background music.

It is another object of the present invention to provide a contents providing system for portable terminal, which is capable of producing an advertisement.

It is another object of the present invention to provide a contents providing system for portable terminal, which supports a function to pay electronic money for downloading an advertisement sound as a ring tone.

It is another object of the present invention to provide a contents providing system, which supports a function to pay the telephone charge or charged contents services with the electronic money obtained by using an advertisement sound as a ring tone.

It is another object of the present invention to provide a contents providing system for portable terminal, which is capable of downloading various sounds from a contents server and using the downloaded sound as key tones.

It is another object of the present invention to provide a contents providing system for portable terminal, which is capable of setting key tones such that different tones are produced when the keys are pushed.

It is another object of the present invention to provide a contents providing system for portable terminal,

It is still another object of the present invention to provide a contents providing system for portable terminal, which is capable of transmitting previously stored background music sound or the background music sound processed in funny manner, or producing various key tones so as to make the conversation comfort.

To achieve the above objects, the contents-providing system for portable terminal, according to a preferred embodiment of the present invention, comprises a communication network; a contents providing server storing at least one terminal mode execution program and contents in a form of database, the program and contents being able to be downloaded; and a plurality of portable terminals that downloads the terminal mode execution program and contents, the portable terminal creating new mode using the terminal mode execution program.

The new mode created by operating the execution program downloaded from the contents server is one of an incoming call rejection mode, background music mode, advertise ring tone mode, anti key tone mode.

The portable terminal operating in the incoming call rejection mode includes a storage for storing announcement messages and a controller for controlling the portable terminal so as to transmit the announcement message to a caller's terminal when to be transmitted when the portable terminal receives a incoming call in the incoming call rejection mode.

The storage stores a plurality of caller's phone numbers and announcement messages associated with the caller's phone numbers and the controller sets the portable terminal to a first incoming call rejection mode by a user's manipulation, extracts the caller's phone number from an incoming call, and determines whether or not there is a phone number identical with the extracted caller's phone number in the storage, and transmits the announce message associated to the caller's phone number when there is the phone number identical with the caller's phone number.

The announcement message transmitted to the caller's terminal is a background music sound or a text message.

The controller stores the caller's phone number to which the announcement message is transmitted, display the caller's phone number on a display screen together with a message urging the user to call using the displayed phone number.

The controller supports a function in which the controller registers specific phone numbers to which a call is automatically made when the caller's phone number extracted from the incoming call matches one of the specific phone numbers, after the first incoming call rejection mode is released, and stores information on the time at which the automatic call is made, in association with the caller's phone number.

Also, the controller extracts the caller's phone number from the incoming call received and stores the extracted caller's phone number into the storage when a second incoming call rejection mode is selected by a user.

The controller stores a caller's message received from a calling terminal in the first incoming call rejection mode or second incoming call rejection mode and displays an announcement message notifying the caller's message is stored in the storage after the first incoming call rejection mode and the second incoming call rejection mode.

The caller's message inputted through the caller's terminal is a background music sound or text message.

The first incoming call rejection mode or the second incoming call rejection mode is released by a key signal inputted by the user or automatically released at a preset time.

The contents providing server stores at least one sound data to be used as a background music of the portable terminal, the sound data being downloaded by the portable terminals in response to a user's request; and the portable terminal downloads the sound data and stores the downloaded data in the storage such that the sound data can be played as a background music during a conversation on communication channel in the background music mode.

The portable terminal operating in the background music mode comprises a sound data storage for storing one or more reference voice commands and output sound data associated with the reference voice commands; a menu selection module for providing a function in that the portable terminal establishes online connection with the contents providing server and performs mode conversion between a standby mode and a mailbox mode using a voice command; a voice recognition module for converting a user's voice into a digital signal so as to recognize a user's voice command and comparing the user's voice command with the reference voice commands; a controller for controlling a whole system of the portable terminal according to menu selection using the menu selection module, compares the user's voice command inputted through the voice recognition module with the reference voice commands, and plays one of the output sound data associated the reference voice command; and a voice signal output module for outputting the output sound data under control of the controller.

The sound data storage further stores background music sound and key tone data to be used as the background music during the conversation in a portion other than a portion in which the output sound data is stored and the controller controls such that the background music sound is played and outputted.

The controller controls the portable terminal such that the background data is played and outputted in order set by the user or the key tones are outputted as the background music during the conversation.

The controller controls the portable terminal such that the background music sound are randomly selected, and the selected background music sound is played and outputted.

The controller controls the portable terminal such that the background music sound is transmitted to and outputted by the counterpart caller's terminal.

The sound data storage stores a plurality of output sound data associated with one reference voice command; and the controller recognizes the user's voice command so as to play and output the output sound data according to the user's voice command.

The sound data storage stores at least one output sound data associated the user's voice command; and the controller determines the output sound data as the background music according to a user's manipulation.

The contents providing server has a plurality of advertisement sounds to be used as ring tones of the portable terminal in the advertisement ring tone and information on electronic money pay rates associated with the advertisement sounds such that the contents providing server stores the information on user accounts in which the electronic money is accumulated when the advertisement sounds is downloaded in response to a user's request, together with the user information into another storage means, the electronic money being able to be used for paying for pay services; and the portable terminal downloads an execution program and resides the downloaded execution in order for an associated icon is displayed on a display screen, such that the portable terminal tries to access the contents providing server, when the icon is selected, and downloads and stores the advertisement sound into the storage, the downloaded advertisement sound being registered as the ring tone associated with a specific phone number such that the advertisement sound is replayed when an incoming call contains the registered specific phone number.

The electronic money paying for different advertisement sounds are set in different pay rates.

The contents providing server checks a number of downloading the advertisement sounds and transmitting an emulator program to the portable terminal such that an icon linked to the emulator program is displayed on the display screen of the portable terminal, and the portable terminal tries to establish an online connection with the contents server using the emulator program when the icon is selected by the user such that a service page is displayed on the display screen for selecting the advertisement sound when the online connection is established.

The contents providing server pays additional electronic money to the user according to the number of uses of the advertisement sounds as the ring tone.

The contents providing server pays additional electronic money to the user according to the number of uses of the advertisement sounds as the ring tone and supports a function which allows the electronic money to be paid for the phone service when the electronic money reaches a predetermined value.

The contents providing server pays additional electronic money to the user according to the number of uses of the advertisement sounds as the ring tone and supports a function which allows the electronic money to be changed into an exchange ticket, which is distributed to the user.

The portable terminal operating in the advertisement ring tone mode includes: a storage for storing a plurality of advertisement sounds and an emulator program downloaded from the contents providing server, the emulator program counting a number of uses of the advertisement sounds as the ring tone and uploads counted number to the contents server; a communication circuit including an RF transceiver and modem, the communication circuit transmitting a download request signal to the contents providing server, receiving the advertisement sound information from the providing server, and configuring communication environment with base stations or repeaters; and a controller for controlling the portable terminal so as to establish an online connection with the contents providing server, download and store the advertisement sounds and emulator program into the storage, determine whether or not a ring tone is outputted in accordance with a paging signal received through the communication circuit, and outputs the advertisement stored in the storage as the ring tone through the speaker when it is determined that the ring ton is outputted, wherein the emulator program operates when the portable terminal is turned on, recognize a kind of the advertisement sound, and counts and stores the number of outputs of the advertisement sound as the ring tone.

The contents providing server has a plurality of key tones to be used by the portable terminal in a key tone mode and transmits the key tones in response to a download request, and the portable terminal downloads the key tones from the contents providing server according to the user's manipulation and outputs the key tone as set by the user during dialing.

The key tones can be set such that each key button activates different key tones.

The key tone is one of a melody, natural sound, mechanical composite sound, recorded voice which can be used in a situation in which the user can not speak.

The preferred embodiment of the present invention will be described hereinafter with reference to the accompanying drawings.

As shown in FIG. 1, the contents-providing system for portable terminal, comprises a communication network 100; a contents providing server 200 storing at least one terminal mode execution program and contents in a form of database, the program and contents being able to be downloaded; and a plurality of portable terminals 300 that downloads the terminal mode execution program and contents, the portable terminal creating new mode using the terminal mode execution program.

The new mode operated by the execution program provided by the contents providing server is one of an incoming call rejection mode, background music mode, advertise ring tone mode, and key tone mode.

The functions and the structures of the contents providing server 200 and the portable terminal 300 are described in detail in view of respective modes provided by the present invention and the similar elements of the contents server and the portable terminal 300 in the respective mode will be denoted with the same reference numerals.

### BRIEF DESCRIPTION OF THE DRAWINGS

FIG. 1 is a conceptual view illustrating a contents-providing system for portable terminal according to the present invention;

FIG. 2 is a schematic block diagram illustrating a portable terminal of FIG. 1 operating in an incoming call rejection mode;

FIG. 3 is a schematic block diagram illustrating a portable terminal of FIG. 1 operating in a background music mode;

FIG. 4 is a schematic block diagram illustrating a portable terminal of FIG. 1 operating in an advertisement ring tone; and

FIG. 5 is a schematic block diagram illustrating a portable terminal of FIG. 1 operating in a key tone mode.

### BEST MODE FOR CARRYING OUT THE INVENTION

The present invention will be describe hereinafter with reference to the accompanying drawings.

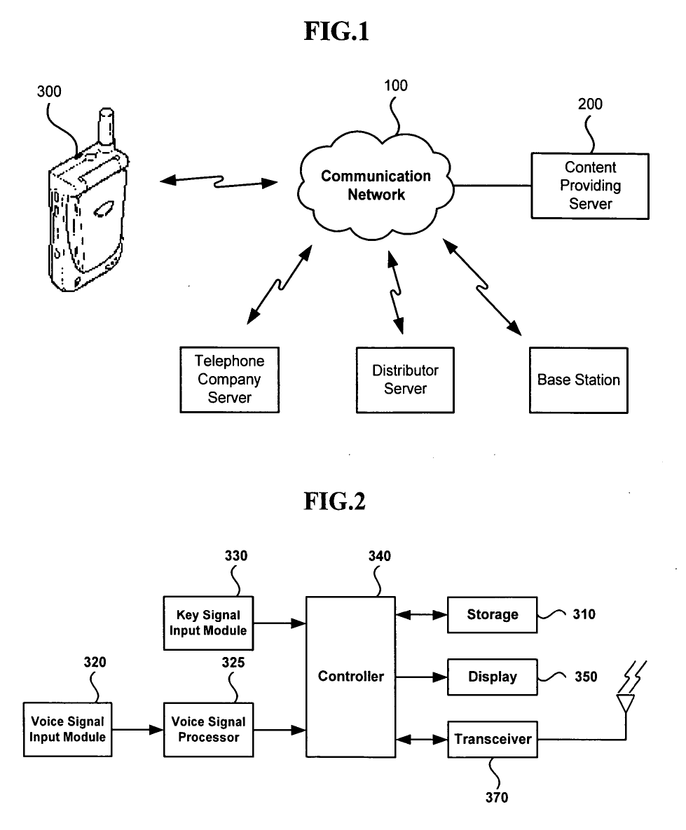

Referring to FIG. 1, the present invention comprises a communication network 100, a contents server 200 stored execution programs for operating portable terminal 300 in at least one mode and contents in a form of database so as to support the portable terminal 300 downloading the execution programs and contents in response to a user's request, the portable terminal 300 downloading the execution program and contents from the contents server 200 through the communication network 100 so as to create a new mode and operating the portable terminal 300 using the execution program and contents.

In this case the new mode created by the execution program provided by the contents server is at least one of a incoming call rejection mode, background message transmission mode, advertisement ring tone, and key tone producing mode.

The structures and functions of the contents server 200 and the portable terminal 300 will be described in more detail for the respective modes provided by the present invention. For simplifying the explanation, the elements having similar functions will be denoted by same reference numerals.

Incoming Call Rejection Mode

Prior to describing the present invention in detail, a first incoming call rejection mode and second incoming call rejection mode will be explained. In the second incoming call rejection mode the receiving terminal transmits the same voice or text message to all of the calling terminals as incoming call rejection message. In the first incoming call rejection mode, the user registers a previously stored voice or text message, for example “I can receive your call 30 minutes later. Please call later or leave you message,” as the incoming call rejection message such that the portable terminal transmit the registered message to the calling terminal. When the phone number of the calling terminal is not registered in the receiving terminal, the receiving terminal transmits the voice or text message which is used in the second incoming call rejection mode.

FIG. 2 is a schematic block diagram illustrating a structure of the portable terminal in the incoming call rejection mode.

As shown in FIG. 2, when the second incoming call rejection mode is selected by the user, contents-providing system for portable terminal of the present invention comprises a storage 310 for storing the general incoming call rejection message for all of the callers, a plurality of phone numbers and specific incoming call rejection message associated with the stored phone numbers; a key signal input module 330 for inputting various key signals such as key number signals, incoming call rejection signal, reception unavailable signal, and etc.; a voice signal input module 320 for inputting the voice of the user through a microphone as the incoming call rejection message or reception unavailable signal; a voice signal processing module 325 for processing the user voice inputted through the voice signal input module 320 so as to convert the voice signal into digital signal and storing the converted digital signal in the storage under control of the controller 340 to be explained later; a display unit for displaying the caller's phone number and various message; a transceiver 370 for transmitting the incoming call rejection message or reception unavailable message which is read by the controller 340 to the calling terminal in the first incoming call rejection mode or the second incoming call rejection mode; and a controller 340 for setting the portable terminal to the first incoming call reception mode by the user's intension, extracting the caller's phone number from the incoming call, determining whether or not the caller's phone number is stored in the storage 319 so as to transmit the incoming call rejection message associated with the phone number to the calling terminal.

The reception unavailable message and incoming call rejection message are voice or text messages.

The controller 340 stores the phone number of the calling terminal to which the incoming call rejection message is transmitted in the storage 310, display the phone number of the calling terminal and call request message on the display unit 350 when the first call rejection mode is released.

The controller 340 registers specific phone numbers by the user's input so as to establish the communication channel to the calling terminal of which phone number is identical with one among the phone numbers extracted in the first incoming call rejection mode when the first incoming call rejection mode is released, and stores information relative to the automatic communication channel establishment in the storage 310 with the associated phone number.

Also, the controller 340 extracts the caller's phone number contained in the incoming call received in the second incoming rejection mode, stores the phone number in the storage 310, transmits the reception unavailable message to the caller, and converts the second incoming call rejection into the normal voice communication mode.

Also, the controller 340 stores the voice or text message received in the first incoming call rejection or the second incoming call rejection mode so as to notify the user that there is a voice or text message received in the first or second incoming call rejection mode, after the first incoming call rejection mode or second incoming call rejection mode is released.

The first incoming call rejection mode or the second incoming call rejection mode is released in response to the key signal inputted by the user or is released after a configured time is finished.

The operation of the above structured portable terminal in the incoming call rejection mode will described. Firstly, the user inputs a message (hereinafter, which is called an announcement message) for announcing the portable terminal is in the first incoming call rejection mode or second incoming call rejection mode, using a message input menu, such that the announcement message is transmitted to the calling terminal. The announcement message can be a voice or text message.

That is, the user inputs his/her voice through a microphone as the input part 320 when he wants to use his/her own background music sound as the announcement message. The background music sound is converted into a digital signal by the voice signal processing module 325 so as to be stored in the storage. The text message is inputted through the key signal input module (330) and stored the storage 10 under control of the controller (340).

When the portable terminal is in the first incoming call rejection mode, the user can configure the portable terminal such that the different announce message is transmitted to the calling terminal according to the calling terminal. That is, if the user registers a phone number as a specific management phone number and associates the specific management phone number with a specific announcement message, the controller 340 transmits the specific announcement message when where is an incoming call and the phone number contained in the incoming call matches with the registered specific management phone number.

The first incoming call rejection mode and the second incoming call rejection mode will be described with reference to FIG. 2 in more detail. A user inputs a mode selection signal to the controller 340 through the key signal input module 330.

The controller determines which operation mode is activated according to the mode selection signal inputted through the key signal input module 330. If the inputted mode selection signal is for the first incoming call rejection mode, the controller 340 converts the present operation mode into the first incoming call rejection mode.

The controller 340 checks continuously whether there is an incoming call. If there is an incoming call, the controller 340 extracts the caller's phone number from the incoming call. The controller 340 determines whether the extracted phone number matches with one of the previously registered specific management phone number. If the caller's phone number is matches with one or the specific management phone number, the controller displays the caller's phone number on the display unit 350 and transmits a specific announcement message associated with the phone number to the calling terminal through the transceiver 370, such as “Good morning, Mr. XXX. I am driving now. I and calling you about 30 minutes later,” or “Hi, I can not receive your call now because I am in a meeting. I will call you later.” Also, the controller 340 transmits a text message such as “at a meeting,” “at a wheel,” “on a trip,” “at an excise” to the calling terminal instead of the background music sound through the transceiver 370.

The controller 340 stores the caller's phone number in the storage 310 and then determines whether or not a first incoming call rejection mode release request by the user. The controller 340 maintains the first incoming call rejection mode if the first incoming call rejection mode release request is not inputted. On the other hand, if the first incoming call rejection mode release request is inputted, the controller 340 converts the first incoming call rejection mode into the normal voice communication mode and then displays the caller's phone number and call request message on the display unit 350 in order for the user calls the counterpart terminal from which the incoming call has been transmitted in the first incoming call rejection mode.

The controller 340 can automatically try to make a call to the counterpart caller using the phone number of the incoming call rejected in the incoming call rejection mode at predetermined time point. The phone number to which automatic call is tried and the time at which the automatic call is tried should be previously set and stored in the storage 310 by the controller 340.

If the first incoming call rejection mode release request is not inputted, the controller 340 determines whether or not a second incoming call rejection mode selection signal is inputted. If the second call rejection mode selection signal is inputted, the controller 340 converts the present operation mode into the second call rejection mode.

The controller 340 continuously checks whether there is an incoming call. When there is a incoming call, the controller 340 extracts the caller's phone number contained in the incoming call and recognizes the caller's phone number so as to display on the display unit.

The controller 340 transmits a previously registered voice announcement message, exemplary “I can not receive your call now. I will call you as soon as possible,” to the calling terminal through the transceiver 370 and stores the caller's number in the storage 310. Also, the controller 340 transmits a text message such as “at a meeting,” “at a wheel,” “on a trip,” “at an excise,” to the calling terminal through the transceiver 370 and displays the transmitted text message on the display unit in order for the user can recognize the which message is transmitted.

The controller 340 determines whether or not a second incoming call rejection mode release request is inputted. The controller 340 maintains the second incoming call rejection mode if the second call rejection mode release request is not inputted, and the controller 340 converts the present operation mode of the portable terminal into the normal voice communication mode.

The controller 340 stores the background music sound transmitted from the caller's terminal into the storage 310 in the first incoming call rejection mode and the second incoming call rejection mode, and display an associated announcement message indicating the background music sound is received from the caller when the first incoming call rejection mode or the second incoming call rejection mode is released.

Also, the controller 340 releases the first incoming call rejection mode or the second incoming call rejection mode according to the key signal inputted by the user, or automatically releases the first incoming call rejection mode or second incoming call rejection mode at the time set during the operation mode selection.

Background Music Mode

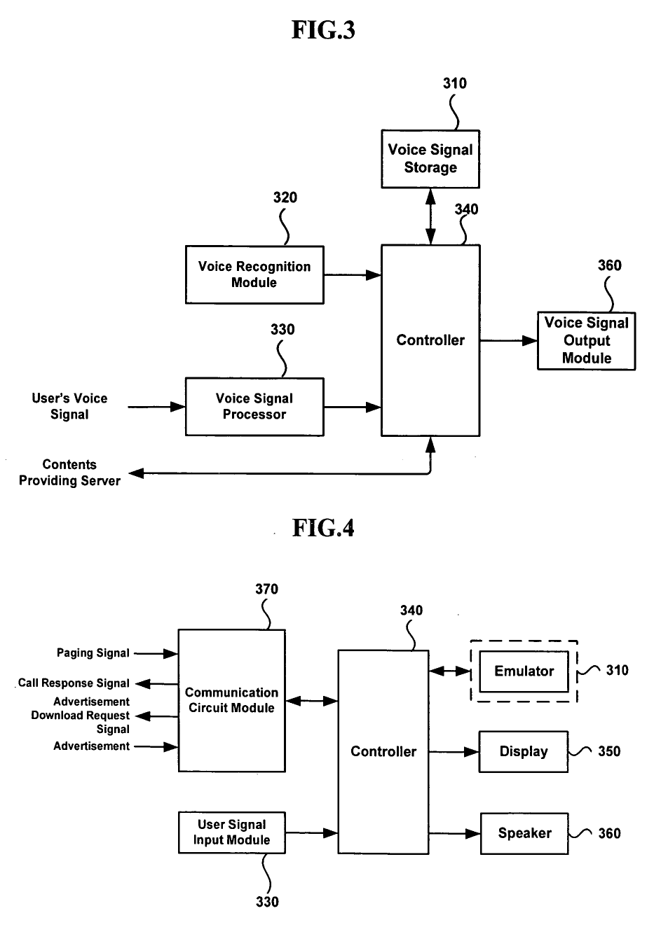

FIG. 3 is a schematic block diagram illustrating a structure of the portable terminal in the background music mode.

The contents providing server 200 of FIG. 1 stores one or more background music sounds which can be downloaded through the communication network 100 in response to the user's request and the portable terminal 300 can download the background music sounds from the contents providing server 200 and stores the downloaded background music sound in a storage so as to replay a background music sound selected by the user during the telephone conversation.

As shown in FIG. 3, the portable terminal 300 includes a storage 310 for storing a plurality of reference voice commands and output sound messages associated to the reference voice commands; a menu selection module 330 providing a network access item such that the portable terminal 300 can access to the contents providing server 200 using the network access item and a mode selection item so as to select a standby mode or a mail box mode; a voice recognition module 320 for converting inputted user's voice command into a digital signal so as to compare the inputted user's voice command with the reference voice command; a controller 340 for controlling the whole system according to the selected menu item and matching the user's voice command with the reference voice command which is stored in the storage 310 so as to replay the output sound message associated with the reference voice command as analog voice signal; and a voice signal output module 360 for outputting the output sound message under control of the controller 340.

The storage 310 of the portable terminal 300 stores a plurality of background music items and key tones in an area thereof other than where the output sound messages is stored, the background music items and key tones being outputted while the communication channel is established.

When the communication channel is established, the background music item is automatically replayed and outputted or the key tones are outputted as the background music when the associated key is pushed under control of the controller 340. The background music items can be replayed and outputted in an order configured by the user under control of the controller. Also, the controller 340 can randomly select background music items and replay the selected background song.

One reference voice command can be linked to one of a plurality of output sound messages stored in the storage 310 such that the controller 340 replays and outputs the background music sound selected by recognizing the user's voice command.

Also, the storage 340 of the portable terminal stores one or more output sound messages linked one reference voice command such that the controller determines the output sound message according to the user's manipulation.

The voice signal output module is a speaker phone.

The operation of the above structured voice recognition portable terminal will be described with reference to FIG. 1 or FIG. 2 in more detail.

Firstly, the controller 340 of the portable terminal 300 determines whether or not a user's voice command is inputted through the voice recognition module 320. If a user's voice command is inputted, the controller 340 determines whether or not there is a reference command matched with the inputted voice command among the reference command stored in storage 310.

If there exists the reference voice command corresponding to the inputted user's background music sound, the controller determines whether or not there exists output sound message associated with the reference voice command so as to output the output sound message through the voice signal output module 360.

For example, in case “Honey!” is stored as the reference voice command and “Love song” is stored as the associated output sound message, the portable terminal 300 replays the “love song” as the output sound message when the user speaks “Honey!”

In case “congratulation!” is stored as the reference voice command and “clap sound” is stored as the associated output sound message, the mobile 300 replays the clap sound as the output sound message when the user speaks “congratulation !”

One output sound message can be linked with more than one reference voice command and one reference voice command can be linked with more than one output sound message as in the following examples:
“Honey,” “I love you,” “I'd like see you” - - - “Love song”
“Congratulation” - - - “clap sound,” “fanfare,” “What is,” “something?”

When the user tries to access the contents providing server 200, the controller 340 establishes the connection to the contents providing server 220 so as to download the background music sounds and stores the downloaded background music sound into the storage 310.

In the present invention, the controller 340 reads and replays the background music and outputs the background music through the voice signal output module 360 when the communication channel is established. Of cause, the controller 340 outputs the background music in a level lower than that of the counterpart caller's voice outputted from the voice signal output module 360.

Also, the controller 340 transmits the user's voice and the background music as well as outputs the background music through the voice signal output module 360 of the user's own portable terminal such that the user and the counterpart caller can have a conversation while listening to the background music at the same time.

The controller 340 selects the background music in two manners, i.e., a first background music play procedure in which the controller 340 plays the background music items in an order set by the user and a second background music play procedure in which the controller 340 replays the background music items in a random order.

In the first background music play procedure, the controller 340 controls such that the background music items are played in various manners. For example, the controller 340 outputs different music in different time period, outputs previously stored key tones during the voice communication when the specific key is pushed, or replays different background music according to the phone number of the incoming call.

The present invention provides various functions such that the background music is played or not according to the user's manipulation, and the background music is replayed, stopped, or transmitted according to repetition number of the push of specific button.

Advertisement Ring Tone

FIG. 4 is a schematic block diagram illustrating a structure of the portable terminal in an advertisement ring mode.

The contents providing server 200 of FIG. 1 has a plurality of advertisement items to be used as ring tones of the portable terminals and information on payment rates of electronic money corresponding to the advertisement items, stores user information and points of the electronic money accumulated when the user downloads different advertisement, and provides pay services to the user with the electronic money.

After the portable terminal 300 establishes an online connection to the contents providing server 200 through the communication network 100, the portable terminal downloads the advertisement and stores the downloaded advertisement as the ring tone. The advertisement can be set as the ring tone for a specific phone number such that the advertisement is outputted as the ring tone when the phone number contained in a paging signal matches with the specific phone number.

The contents providing server 200 gives the user electronic money points for the advertisement such that the accumulated points can be used for paying for telephone charge and be changed with exchange ticket for off-line usage, the exchange ticket being distributed to the user if the points exceeds a predetermined amount.

In case that the points is used for paying the telephone charge or changed with the exchange ticket, the contents provider has made a contract with the telephone company such that the contents providing server 200 transfers the information on cash amount converted from the points to an accounting server of the telephone company. The accounting server of the telephone company provides the information on the converted cash amount on a phone bill and charges the amount subtracted the converted cash amount from the whole charging amount.

Also, the contents provider makes a contract with a distributor which draws the exchange ticket, such that the contents providing server 200 transfers the information on the cash mount converted from the points to the accounting server of the distributor. The accounting server of the distributor draws and distributes an exchange ticket having a face value of the money amount. That is, the contents server 200 gives the user the points, accumulated whenever the user uses the advertisement as the ring tone, and stores the point information in association with the user information.

The points accumulated is the manner is accounted in unit of a thousand, i.e. 1000, 2000, 3000, and etc., such that at least one exchange ticket having different face value is selected by the user. The contents providing server transfers the information including the user's name, social security number of the user, user's address, and the kind of the exchange ticket to accounting server of the distributor.

The accounting server of the distributor delivers the selected exchange ticket by registered mail, electronic mail, or the like such that the user can use the exchange ticket for buying products at the affiliate stores.

The electronic money points paid for different advertisement sounds are set in different pay rates.

That is, the electronic money amount to be paid for the advertisement is determined by a contract between the contents provider and the advertiser. Accordingly, it is expected that the user prefers to download the advertisement sound for which much electronic money are paid.

Also, the contents providing server 200 transmits an emulator program which counts and uploads the number of use of the advertisement sound as the ring tone of the portable terminal while the portable terminal 300 is connected to the contents providing server 300.

In the present invention, the emulator is a communication program which enables the portable terminal to operate as the contents providing server as a host computer. The emulator is automatically downloaded when the portable terminal 200 tries to firstly download the advertisement sound after the mobile is connected to the contents providing server 200. The emulator establish an online connection between the portable terminal and the contents providing server 200 such that the portable terminal 300 downloads the advertisement sounds and the number of the uses of the advertisement sounds as the background music are counted and uploaded to the contents providing server. Also, the emulator can be downloaded in a form of an execution program when it is requested by the user such that the emulator is installed in the portable terminal and an icon is created on the display screen of the portable terminal.

The emulator operates when the portable terminal 300 turns on and counts the number of the outputs of the advertisement sound downloaded from the contents providing server 200 as the ring tone and periodically uploads the counted number to the contents providing server 200.

Also, the emulator tries to establish the online connection between the portable terminal 300 and the contents providing server 200 when the icon is selected by the user, and displays a service page in order for the user to select the advertisement sounds which is to be downloaded and used as the ring tone of the portable terminal 300.

Also, the contents providing server 200 may give the user additional electronic money points according to the number of the uses of the advertisement sound as the ring tone.

The contents providing server 200 gives the user the additional electronic money points according to the number of the uses of the advertisement sound such that the electronic money points can be used for paying the telephone charge or changed with the exchange ticket which can be used in real life.

As shown in FIG. 4, the portable terminal 300 has an operating program for controlling the whole system and a plurality of advertisement sounds downloaded from the contents providing server 200, includes a storage 310 storing an emulator for uploading the count number of the outputs of the advertisement sound to the contents server 200, a storage storing an emulator program downloaded from the contents providing server 200, the emulator program counting a number of uses of the advertisement sounds as the ring tone and uploads counted number to the contents server; a communication circuit 370 including an RF transceiver and modem, the communication circuit 370 transmitting a download request signal to the contents providing server 200, receiving the advertisement sound information from the providing server 200, and configuring communication environment with base stations or repeaters; a controller 340 for controlling the portable terminal so as to establish an online connection with the contents providing server 200, download and store the advertisement sounds and emulator program into the storage 310, determine whether or not a ring tone is outputted in accordance with a paging signal received through the communication circuit 370, and outputs the advertisement stored in the storage as the ring tone through the speaker 360 when it is determined that the ring ton is outputted.

The signal input module 330 is a key pad including a plurality of buttons of 0˜9, send, end, arrow, and etc. When the buttons are pushed by the user associated electric signals are produced.

The display unit 350 displays the numbers and characters corresponding to the respective buttons under control of the controller 340.

The above structured contents providing server 200 supports a function in that the user can select and download the advertisement sounds that is to be used as the ring tone.

The contents providing server 200 categorizes the advertisements according to the business fields such as electric appliances, beverages, snacks, cosmetics, etc. Each category includes a plurality of advertisement sounds such that the user can select the advertisement sounds in the category.

For example, if the electronic appliance category is selected, the advertisers such as Samsung, Daewoo, LG, etc. are displayed and then if a specific advertiser is selected, e.g. Samsung, the advertisement list provided each advertiser is displayed together with the electronic money pay rates associated with each advertisement. If the user selects and request one of the advertisements, the advertisement is downloaded to the portable terminal 300 through the communication network 100.

The contents providing server 200 stores the phone number of the user's portable terminal to which the advertisement is downloaded and uses the phone number as the identification information and deposits the electronic money associated with the downloaded advertisement to the user's account.

Thus, the user can use the electronic money for other pay services as well as for paying the telephone bill of the portable terminal 300.

When the portable terminal 300 requests downloading the advertisement, the contents providing server 200 transmits the emulator program to the portable terminal 300.

The emulator has various functions. Firstly, The emulator counts the number of outputs of the advertisement as the ring tone through the speaker and uploads the output numbers to the contents server 200. The advertisement providing server 200 pays additional electronic money points according to the output numbers of the advertisement.

Second function of the emulator is to enable the user to set the priority of the advertisements stored in the storage 310 of the portable terminal 300 such that the advertisements are outputted from the advertisement having a higher priority of the advertisements.

For example, when the user has downloaded the Samsung refrigerator advertisement, Daewoo laundry machine advertisement, and LG television, the user can prioritize the advertisements exemplary in an order of Samsung, Daewoo, and LG. In this case, the Samsung refrigerator advertisement “Zipel is love” is outputted as the ring tone through the speaker 360 for a first incoming call received after the priority is configured. Also, the Daewoo Laundry machine advertisement “No detergent Laundry machine, Midas” is outputted as the ring tone for the next incoming call through the speaker 360, and the LG television advertisement “Image quality of future world, LG Flatron” is outputted as the ring tone for the following incoming call through the speaker 360.

The controller 340 of the portable terminal 300 downloaded the advertisements as for the ring tone from the contents providing server 200 determines whether or not the number contained in the paging channel received through the paging channel which is always opened to the base station and the communication circuit module 370 matches with the its own number stored in the storage 310 of the portable terminal.

If the number contained in the paging signal matches with its own number, the controller 340 transmits a response signal to the base station through the communication circuit module and outputs the advertisement through the speaker 360 such that the user recognizes that there is an incoming call by advertisement ring tone outputted from the speaker 360.

When the emulator is downloaded from the contents providing server 200, the controller 340 controls in order for the emulator performs the advertisement ring procedure.

Key Tone Mode

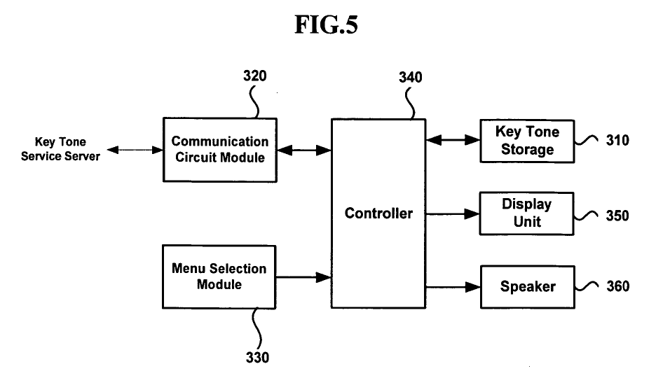

FIG. 5 is a schematic block diagram illustrating a structure of the portable terminal in a key tone mode.

The contents providing server 200 of FIG. 1 has a plurality of key tones transmits the key tones to the portable terminal through the communication network in response to the user's request.

The portable terminal 300 selectively downloads at least one key tone according to the user's manipulation and stores the downloaded key tone so as to set the key tone to be linked with a specific button. Accordingly, when the button is pushed, the associated key tone is outputted.

As shown in FIG. 5, the portable terminal 300 comprises a key tone storage 310 for storing the key tones downloaded from the contents providing server 200; a communication controller 320 for transmitting a key tone request signal to the contents providing server 200 and downloading the key tones from the contents providing server 200 through the communication network 100; a user signal input module 330 as a dial keypad including dial buttons having numbers ˜9, send button, end button, menu button, arrow buttons, the user signal input module 330 outputting associated key tones when one of the button is pushed; a controller 340 for controlling the whole system by recognizing which button is pushed according to the electric signal from the user signal input module 330, checking which key tone is associated the pushed button so as to output the associated key tone; a display unit 350 for displaying numbers or text data under control of the controller 340; and a speaker 360 for outputting the key tone outside when the key button is pushed, under control of the controller 340.

The above structured contents providing server 200 according to the present invention supports the portable terminal downloading the key tones the user want. For example, the portable terminal 300 can downloads a group of key tones to be associated with respective buttons of the portable terminal or individual key tone for each button from the contents providing server 200.

Also, the content providing server 200 has various key tones. That is, the contents providing server 200 provides melodies (pop song, rhythm, classical music, etc.), animal crying sound, natural sound (wind sound, raining sound, water stream sound, waterfall sound, etc.), human voice (yelling, confession, laughing sounds), recorded voice sound which can be used in a situation when the user can not speak, and the mechanical composite sound (airplane sound, horse running sound).

When the user select a menu for establishing online connection with the contents providing server 200 through the user signal input module 330 of the portable terminal 300, the controller 340 controls the communication controller 320 so as to establish the online connection with the contents providing server 200 through the communication network 100.

The portable terminal 300 downloads a key tone service page and displays the key tone service page on the display unit 350 under control of the communication controller 320. If the user selects one of the key tones on the key tone service page, the controller 340 transmits a key tone download request signal to the contents providing server 200.

The contents providing server 200 transmits the key tone requested by the key tone download request signal through the communication network 100 and the controller 340 of the portable terminal 300 stores the key tone received through the communication controller 320 into the key tone storage 310.

The controller 340 displays the key tone items on the display unit 350 stored in the key tone storage 310 such that the user can select one of the key tones. If the user selects and sets a key tone for a specific button and the key button is pushed by the user through the user signal input module 330, the controller 340 reads the key tone associated with the button and outputs the key tone through the speaker 360.

The key tone can be changed according to the user's intention and the previously stored key tones can be deleted in the first-in-first-out manner if the number of key tones downloaded is greater than a predetermined number.

The preferred embodiment of the present invention can be extended so that the key tones are outputted when the user pushes the buttons in case that the downloaded key tones are used for the specific buttons of the portable terminal. Also, the phone numbers can be grouped such as loves, friends, and coworkers or in a theme such that the members in the same group can share the same key tones.

For example, the key tones for a specific group may be “I love only you,” “Are you available this evening?” “Don't touch me,” or “Don't try to joke anymore.”

The contents providing server 200 can provide key tones such as the mimetic sounds which is used in cartoons but not used in the real world, chatting jargon, various laughing sounds, incantation, voice sounds having intonations in the form of data base such that the user can download various sounds for key tones.

The contents providing server 200 can be provided with various joywords in the form of the database such that the user can download the joywords for the key tones of his/her portable terminal. Also, the contents providing server 200 can be provided with different character sets in the form of database such that the portable terminal output different response if the user pushes buttons in an incorrect order after the user set the character set for the key tones.

The key tone update/output system supports key tone recording function in that the user directly records his/her voice for key tones and updates the key tones of the portable terminal with the recorded voice sound instead of downloading the key tones from the contents providing server.

As described above, the portable terminal transmits a predetermined announcement sound or text message indicating the reason why the user can not receive the call in response to all the incoming call when the portable terminal enters the second incoming call rejection mode according to the user's selection, and the portable terminal transmits a predetermined announcement sound or text message indicating the reason why the user can not receive the call in response to the incoming call of which phone number matches with the phone number previously registered by the user.

Also, the portable terminal displays an announcement message on the display unit so as to inform the user that there was the incoming call received in the first incoming call rejection mode after the first incoming call rejection mode is released.

Also, the portable terminal automatically tries to call to the phone number contained in the incoming call received during the first incoming call rejection mode after the first incoming call rejection mode is released such that the user can keep the promise as he/she leaved with announcement message in the first incoming call rejection mode.

Also, the present invention enables the portable terminal to output the preset sounds associated with the user's voice command so as to make the conversation comfortable.

Also, the present invention enables the portable terminal to play and output the background music during the conversation so as to make the conversation environment smooth.

Also, the present invention enable the portable terminal transmits the background music to the counterpart user such that the user can listen to the background music with the counterpart caller.

Also, the present invention enables the portable terminal to output an advertisement sound as the ring tone such that the people around the portable terminal can hear the advertisement, resulting in maximization of the advertisement effect.

Also, the present invention enables the user to pay for the pay service with the electronic money given by downloading the advertisement as the ring tone, resulting in economical benefits.

Also, the present invention enables the user to download the key tones from the contents providing server such that the user can enjoy various key tone sounds.

1. A contents-providing system for portable terminal, comprising:
a communication network;
a contents providing server storing at least one terminal mode execution program and contents in a form of database, the program and contents being able to be downloaded; and
a plurality of portable terminals that downloads the terminal mode execution program and contents, the portable terminal creating new mode using the terminal mode execution program.

2. The system of claim 1, wherein the new mode is one of an incoming call rejection mode, background music, message, effective sound mode, advertise ring tone mode, and changeable key tone mode.

3. The method of claim 1, wherein the portable terminal operating in the incoming call rejection mode includes:
a storage for storing announcement messages; and
a controller for controlling the portable terminal so as to transmit the announcement message to a caller's terminal when to be transmitted when the portable terminal receives a incoming call in the incoming call rejection mode.

4. The system of claim 3, wherein the storage stores a plurality of caller's phone numbers and announcement messages corresponding to the caller's phone numbers; and
the controller sets the portable terminal to a first incoming call rejection mode by a user's manipulation, extracts the caller's phone number from an incoming call, and determines whether or not there is a phone number identical with the extracted caller's phone number in the storage, and transmits the announce message associated to the caller's phone number when there is the phone number identical with the caller's phone number.

5. The system of claim 3, wherein the announcement message is a voice or text message.

6. The system of claim 3, wherein the controller stores the caller's phone number to which the announcement message is transmitted, display the caller's phone number on a display screen together with a message urging the user to call using the displayed phone number.

7. The system of claim 6, wherein the controller supports a function in which the controller registers specific phone numbers to which a call is automatically made when the caller's phone number extracted from the incoming call matches one of the specific phone numbers, after the first incoming call rejection mode is released, and stores information on the time at which the automatic call is made, in association with the caller's phone number.

8. The system of claim 6, wherein the controller extracts the caller's phone number from the incoming call received and stores the extracted caller's phone number into the storage when a second incoming call rejection mode is selected by a user.

9. The system of claim 7, wherein the controller stores a caller's message received from a calling terminal in the first incoming call rejection mode or second incoming call rejection mode and displays an announcement message notifying the caller's message is stored in the storage after the first incoming call rejection mode and the second incoming call rejection mode.

10. The system of claim 9, wherein the caller's message is a background music sound or text message.

11. The system of claim 7, the first incoming call rejection mode or the second incoming call rejection mode is released by a key signal inputted by the user or automatically released at a preset time.

12. The system of claim 2, wherein the contents providing server stores at least one sound data to be used as a background music of the portable terminal, the sound data being downloaded by the portable terminals in response to a user's request; and
the portable terminal downloads the sound data and stores the downloaded data in the storage such that the sound data can be played as a background music during a conversation on communication channel in the background music mode.

13. The system of claim 12, wherein the portable terminal operating in the background music mode comprises:
a sound data storage for storing one or more reference voice commands and output sound data associated with the reference voice commands;
a menu selection module for providing a function in that the portable terminal establishes online connection with the contents providing server and performs mode conversion between a standby mode and a mailbox mode using a voice command;
a voice recognition module for converting a user's voice into a digital signal so as to recognize a user's voice command and comparing the user's voice command with the reference voice commands;
a controller for controlling a whole system of the portable terminal according to menu selection using the menu selection module, compares the user's voice command inputted through the voice recognition module with the reference voice commands, and plays one of the output sound data associated the reference voice command; and
a voice signal output module for outputting the output sound data under control of the controller.

14. The system of claim 13, wherein the sound data storage further stores background music sound and key tone data to be used as the background music during the conversation in a portion other than a portion in which the output sound data is stored; and
the controller controls such that the background music sound is played and outputted.

15. The system of claim 14, wherein the controller controls such that the background data is played and outputted in order set by the user or the key tones are outputted as the background music during the conversation.

16. The system of claim 14, the controller controls such that the background music sound are randomly selected, and the selected background music sound is played and outputted.

17. The system of claim 14, wherein the controller controls such that the background music sound is transmitted to and outputted by the counterpart caller's terminal.

18. The system of claim 13, wherein the sound data storage stores a plurality of output sound data associated with one reference voice command; and
the controller recognizes the user's voice command so as to play and output the output sound data according to the user's voice command.

19. The system of claim 13, wherein the sound data storage stores at least one output sound data associated the user's voice command; and
the controller determines the output sound data as the background music according to a user's manipulation.

20. The system of claim 2, wherein the contents providing server has a plurality of advertisement sounds to be used as ring tones of the portable terminal in the advertisement ring tone and information on electronic money pay rates associated with the advertisement sounds such that the contents providing server stores the information on user accounts in which the electronic money is accumulated when the advertisement sounds is downloaded in response to a user's request, together with the user information into another storage means, the electronic money being able to be used for paying for pay services; and the portable terminal downloads an execution program and resides the downloaded execution in order for an associated icon is displayed on a display screen, such that the portable terminal tries to access the contents providing server, when the icon is selected, and downloads and stores the advertisement sound into the storage, the downloaded advertisement sound being registered as the ring tone associated with a specific phone number such that the advertisement sound is replayed when an incoming call contains the registered specific phone number.

21. The system of claim 20, wherein the electronic money points for different advertisement sounds are set in different pay rates.

22. The system of claim 20, wherein the contents providing server transmits an emulator program which counts and uploads a number of using the advertisement sounds as the ring tone to the portable terminal while the portable terminal is connected to the contents providing server, and creates an icon, on a display screen of the portable terminal, which is linked to the emulator program, the portable terminal trying to establish an online connection with the contents server using the emulator program when the icon is selected by the user, a service page being displayed on the display screen for selecting the advertisement sound when the online connection is established.

23. The system of claim 22, wherein the contents providing server pays additional electronic money to the user according to the number of uses of the advertisement sounds as the ring tone.

24. The system of claim 22, wherein the contents providing server pays additional electronic money to the user according to the number of uses of the advertisement sounds as the ring tone and supports a function which allows the electronic money to be paid for the phone service when the electronic money reaches a predetermined value.

25. The system of claim 24, wherein the contents providing server pays additional electronic money to the user according to the number of uses of the advertisement sounds as the ring tone and supports a function which allows the electronic money to be changed into an exchange ticket, which is distributed to the user.

26. The system of claim 20, wherein the portable terminal operating in the advertisement ring tone mode includes:
a storage for storing a plurality of advertisement sounds and an emulator program downloaded from the contents providing server, the emulator program counting a number of uses of the advertisement sounds as the ring tone and uploads counted number to the contents server;
a communication circuit including an RF transceiver and modem, the communication circuit transmitting a download request signal to the contents providing server, receiving the advertisement sound information from the providing server, and configuring communication environment with base stations or repeaters; and
a controller for controlling the portable terminal so as to establish an online connection with the contents providing server, download and store the advertisement sounds and emulator program into the storage, determine whether or not a ring tone is outputted in accordance with a paging signal received through the communication circuit, and outputs the advertisement stored in the storage as the ring tone through the speaker when it is determined that the ring tone is outputted,
wherein the emulator program operates when the portable terminal is turned on, recognize a kind of the advertisement sound, and counts and stores the number of outputs of the advertisement sound as the ring tone.

27. The system of claim 2, wherein the contents providing server has a plurality of key tones to be used by the portable terminal in a key tone mode and transmits the key tones in response to a download request, and
the portable terminal downloads the key tones from the contents providing server according to the user's manipulation and outputs the key tone as set by the user during dialing.

28. The system of claim 27, wherein the key tones can be set such that each key button activates different key tones.

29. The system of claim 27, wherein the key tone is one of a melody, natural sound, mechanical composite sound, recorded voice which can be used in a situation in which the user can not speak.

30. The method of claim 2, wherein the portable terminal operating in the incoming call rejection mode includes:
a storage for storing announcement messages; and
a controller for controlling the portable terminal so as to transmit the announcement message to a caller's terminal when to be transmitted when the portable terminal receives a incoming call in the incoming call rejection mode.

31. The system of claim 8, wherein the controller stores a caller's message received from a calling terminal in the first incoming call rejection mode or second incoming call rejection mode and displays an announcement message notifying the caller's message is stored in the storage after the first incoming call rejection mode and the second incoming call rejection mode.

32. The system of claim 8, the first incoming call rejection mode or the second incoming call rejection mode is released by a key signal inputted by the user or automatically released at a preset time.
